(19) United States
(12) Patent Application Publication
(10) Pub. No.: US 2007/0265840 A1
(43) Pub. Date: Nov. 15, 2007

(54) Signal processing method and device

(76) Inventors: Mitsuyoshi Matsubara, Yokohama (JP); Takeshi Otani, Kawasaki (JP); Kaori Endo, Kawasaki (JP); Yasuji Ota, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/826,122

(22) Filed: Jul. 12, 2007

Related U.S. Application Data
(63) Continuation of application No. PCT/JP05/01515, filed on Feb. 2, 2005.

(51) Int. Cl. G10L 19/14; G10L 21/00

(52) U.S. Cl. 704/205

(57) ABSTRACT

In a signal processing method and device which enhance a following speed of an estimated noise in a steep rise section of a noise level and generate little estimation error of a noise spectrum due to an influence of voice in a voice section, a time domain signal that is sampled data of an input signal is extracted, the time domain signal is converted into a frequency domain signal per frame, and an input spectrum is calculated. Furthermore, a minimum value of the input spectrum is acquired, so that a noise spectrum that is a frequency domain signal of a noise component included in the input voice signal is estimated. Moreover, the input spectrum is compared with the noise spectrum, so that whether a section is in a noise section or a mixed section where voice and noise are mixed is determined.

### CROSS-REFERENCE TO RELATED APPLICATION

This application is a continuation of International Application PCT/JP2005/001515 filed on Feb. 2, 2005, the contents of which are herein wholly incorporated by reference.

### BACKGROUND OF THE INVENTION

1. Field of the Invention

The present invention relates to a signal processing method and device, and in particular to a method and device required for voice signal processing in a noise canceller, a VAD (Voice Activity Detection), or the like used for e.g. a digital mobile phone.

2. Description of the Related Art

As a technology of suppressing background noises in a communication voice to make voices easy to hear in a digital mobile phone and the like, a noise canceller can be mentioned. Also, as a technology of saving electric power of a transmitting portion by turning a transmission output ON/OFF depending on a presence/absence of voice, a VAD can be mentioned. For the noise canceller, the VAD, or the like, it is required to determine a section where voices exist or a section where no voice exists during communication.

There can be mentioned, as a method of determining such a section, e.g. a method in which by regarding a long-term average power calculated in the past as a power of noise, the noise power is compared with the power in the present section to determine or judge the present section where the power is large as a voice section. However, with only such a simple power comparison, there is a case that a voice is mistaken as a noise when a background noise level is high and a signal-noise ratio SNRₙ is small.

As measures for this case, a method of performing a section determination by using a frequency domain signal of voice has been proposed (see e.g. patent document 1). Hereinafter, this technology will be described.

A time-frequency conversion is periodically performed to an input signal. The frequency domain signal (hereinafter, referred to as input spectrum) of the input signal is calculated. A long-term average input spectrum calculated in the past is regarded as a noise spectrum (hereinafter, referred to as average noise spectrum). The signal-noise ratio SNRₙ per bandwidth is calculated for each of the average noise spectrum and the input spectrum, so that an average value, a positive (negative) variation amount, a dispersion value, and the like of the signal-noise ratio SNRₙ per bandwidth are calculated in a desired bandwidth. By using these values, the section determination is performed. Also, only when the section is determined as the noise section by the above-mentioned section determination, the average noise spectrum is updated by using the input spectrum. Thus, a more accurate section determination is realized.

Patent document 1: Japanese Patent Application Laid-open No. 2001-265367

However, the average noise spectrum is updated only in the noise section in the prior art technology as described in the Patent document 1. Therefore, when the noise level steeply rises, the noise section is mistaken as a voice section, after which the average noise spectrum is not updated, disadvantageously continuing erroneous determinations.

In order to avoid such erroneous determinations, the Patent document 1 also discloses a method of controlling a time constant of the noise update depending on the signal-noise ratio SNRₙ per bandwidth to update the noise regardless of the section determination result.

However, when the average noise spectrum is updated in the voice section, the average noise spectrum is considerably overestimated by influence of the voice. Therefore, there arises a new problem that the voice section of a low level is easily mistaken as the noise section.

### SUMMARY OF THE INVENTION

It is accordingly an object of the present invention to provide a signal processing method and device in which a following speed of an estimated noise is enhanced in a section with a steeply rising noise level so that estimation error of a noise spectrum due to an influence of voice is hardly generated in a signal section.

(1) In order to achieve the above-mentioned object, the signal processing method according to the present invention comprises: a time domain signal extraction step of extracting a time domain signal that is sampled data of an input signal; a frequency domain signal analysis step of converting the time domain signal into a frequency domain signal per frame and calculating an input spectrum; and a noise estimation step of estimating a noise spectrum that is a frequency domain signal of a noise component included in the input signal by using minimum components of the input spectrum. This will be described by referring to the attached figures.

Firstly, an input signal (noise superimposed voice) as shown in FIG. 1 will be taken as an example. In FIG. 1, sections (i) and (iv) are “noise exclusive sections” (hereinafter, referred to as a noise section). In a section (iii), a steep rise of a noise level occurs. Sections (ii) and (v) are “mixed sections where voice and noise are mixed” (hereinafter referred to as a mixed section). FIG. 2 shows typical input spectrums of the above-mentioned sections (i), (ii), (iv), and (v).

When an input spectrum A in the section (i) is compared with that in the section (ii) in FIG. 2, the minimum portions (filled circles in FIG. 2) of the input spectrum A in the “mixed section of voice and noise” in section (ii) are masked by a superimposed noise where a contribution degree of the noise is high. Therefore, the minimum portions become equal in value to the minimum portions of the input spectrum in the section (i) “noise exclusive section”. The same applies to the case where the noise level is increased, so that the values of the minimum portions of the spectrum in the “noise exclusive section” of the section (iv) becomes equal to those in the section (v) “mixed section of voice and noise”. Hereinafter, the minimum portions of the input spectrum are connected with straight lines, which will be referred to as a minimum spectrum B as shown in FIG. 2.

Based on such a principle, the input spectrum A that is the frequency domain signal is calculated from the input signal of the time domain of a predetermined section at the time domain signal extraction step and the frequency domain signal analysis step in the present invention. At the noise estimation step, the minimum spectrum B is acquired by using the minimum values of the input spectrum A, so that the noise spectrum that is the frequency domain signal of the noise component within the present frame is estimated.

Thus, the estimated noise is calculated by using the minimum portion of the spectrum in the present invention, so that estimation error of the noise spectrum due to the influence of the voice signal is hardly generated and the following speed of the estimated noise can be enhanced in the steep rise section of the noise level.

(2) In the above-mentioned (1), at the noise estimation step, an instantaneous noise spectrum may be acquired per frame as the noise spectrum.

Accordingly, since the estimation step of the noise spectrum is closed or completed within the frame, a higher responsive noise estimation is made possible. Also, the implementation is made possible with a relatively small-scale circuit arrangement.

(3) In the above-mentioned (2), at the noise estimation step, an average noise spectrum of the instantaneous noise spectrums may be acquired over a plurality of frames as the noise spectrum.

Thus, the estimated noise spectrum is averaged over a long time, so that more stable noise estimation is made possible.

(4) Any one of the above-mentioned (1)-(3) may further comprise a section determination step of comparing the noise spectrum with the input spectrum and of determining whether the frame is in a section where voice and noise are mixed or in a noise section without voice.

Namely, as shown in FIGS. 1 and 2, instantaneous noise spectrums based on the input spectrum A and the minimum spectrum B are compared with each other, whereby the mixed section and the noise section can be specified and a system excellent in a noise suppression and power saving can be constructed.

(5) In the above-mentioned (4), at the noise estimation step, when a determination result up to a last frame at the section determination step indicates the mixed section, the average noise spectrum may be acquired by using the instantaneous noise spectrum, and when the determination result indicates the noise section, the average noise spectrum may be acquired by using the input spectrum.

Namely, when the determination result up to the last frame at the section determination step indicates the mixed section, the average noise spectrum is acquired by using the instantaneous noise spectrum as mentioned above. On the other hand, when the determination result indicates the noise section, the instantaneous noise spectrum is not required to be used and the input spectrum has only to be used. Accordingly, the average noise spectrum is acquired based on the input spectrum.

(6) The above-mentioned (4) may further comprise a suppression amount calculation step of calculating a suppression amount per bandwidth for the input signal based on the noise spectrum and the input spectrum and suppressing noise of the input signal, in consideration of a determination result at the section determination step.

Thus, the suppression amount for the input signal is calculated based on the noise spectrum and the input spectrum. However, if the suppression amount is reduced in case of e.g. the mixed section, and the suppression amount is increased in case of the noise section, in consideration of the determination result at the section determination step, more efficient noise suppression is made possible.

Accordingly, the noise estimation with a balance between responsiveness and stability is made possible.

(7) In any one of the above-mentioned (1)-(6), the input signal may comprise a voice signal. In this case, an effective application can be provided.

It is to be noted that signal processing devices for respectively executing the signal processing methods described in the above-mentioned (1)-(7) can be realized.

According to the present invention, a following speed of an estimated noise is enhanced in a steep rise section of a noise level and an estimation error of a noise spectrum due to an influence of voice is reduced in the mixed section, so that an accurate section determination can be performed.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a waveform diagram showing a variation of an input voice signal per section for illustrating a principle of the present invention;

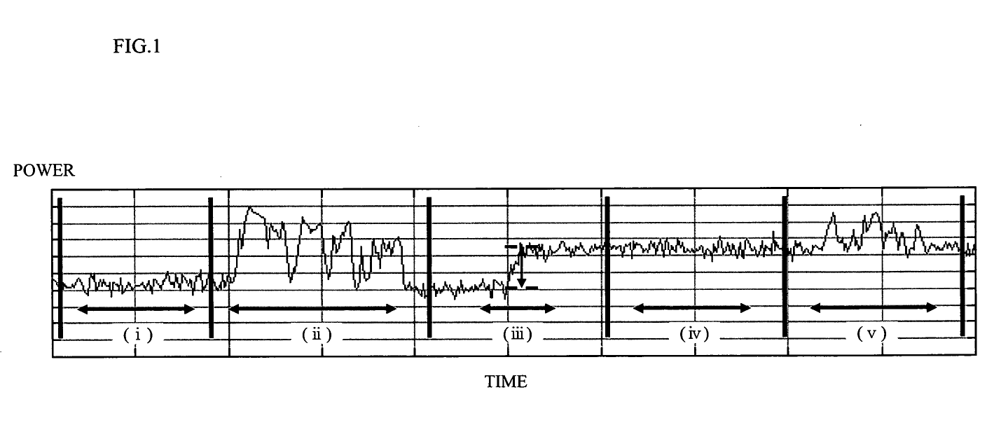

FIG. 2 is a spectrum diagram showing a spectrum of the input voice signal in FIG. 1 per section;

FIG. 3 is an arrangement block diagram showing a signal processing device according to the first embodiment of the present invention;

FIG. 4 is a spectrum diagram showing an example of a minimum spectrum calculated by the signal processing device by the first embodiment of the present invention;

FIGS. 5A and 5B are spectrum diagrams for illustrating a calculation of a correction coefficient for multiplying a minimum spectrum calculated by a signal processing device according to the first embodiment of the present invention;

FIG. 6 is a relationship diagram for illustrating a calculation of a correction coefficient for multiplying a minimum spectrum calculated by a signal processing device according to the first embodiment of the present invention;

FIG. 7 is an arrangement block diagram showing a signal processing device by the second embodiment of the present invention;

FIG. 8 is an arrangement block diagram showing a signal processing device by the third embodiment of the present invention; and

FIG. 9 is an arrangement block diagram showing a signal processing device which functions as a noise suppression device by the fourth embodiment of the present invention.

### DESCRIPTION OF THE EMBODIMENTS

Hereinafter, embodiments of the present invention will be described by referring to attached figures.

### First Embodiment

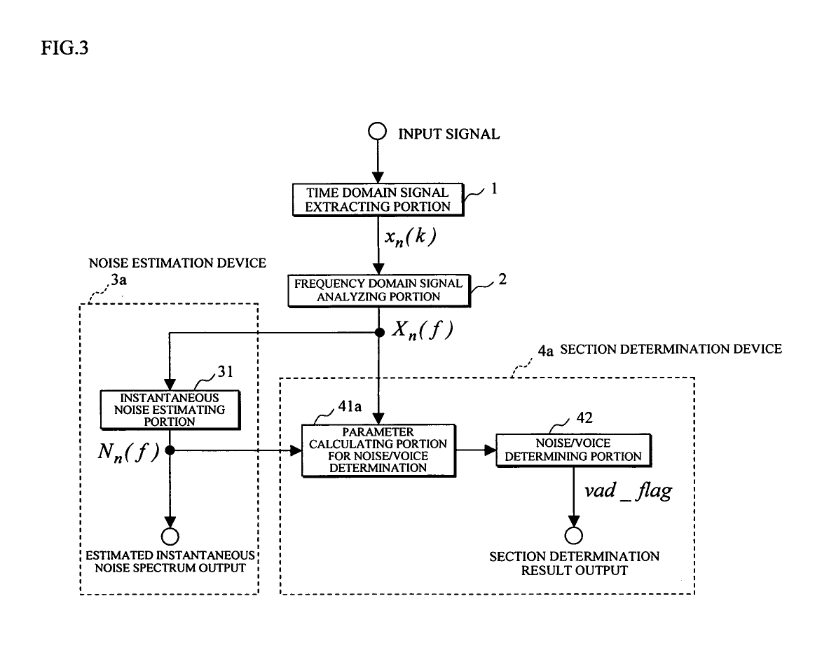

FIG. 3 is an arrangement block diagram showing a signal processing device which functions as a noise estimation device and a noise section determination device according to the first embodiment of the present invention. This signal processing device is composed of a time domain signal extracting portion 1, a frequency domain signal analyzing portion 2, a noise estimation device 3a, and a section determination device 4a. Hereinafter, each block of this signal processing device will be described in detail.

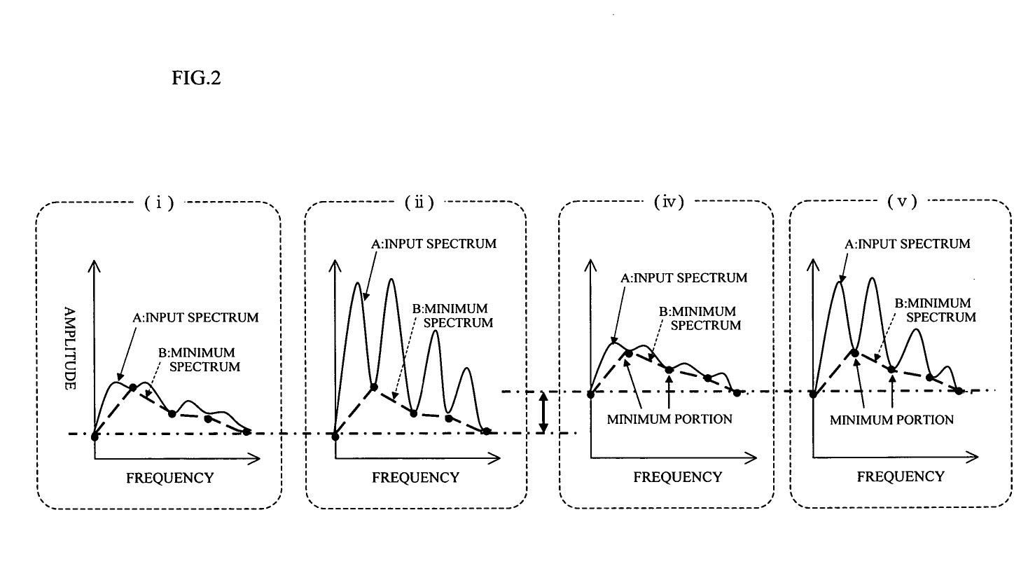

The time domain signal extracting portion 1 quantizes an analog input voice signal, and extracts therefrom a time domain signal xₙ(k) (where “n” indicates a frame No.) as sampled data per unit time (frame). Also, the frequency domain signal analyzing portion 2 performs a frequency analysis to the time domain signal xₙ(k) by using e.g. FFT (Fast Fourier Transform), and calculates an input spectrum Xₙ(f) (corresponding to the input spectrum A in FIG. 2) that is a spectrum amplitude of the input signal. The FFT is described in detail in “Digital signal processing series vol. 1: Digital signal processing (Tujii & Kamata), P94-P120, Shoukoudou”, “Computer music (written by Curtis Roads, translated and edited by Aoyagi et al.)” P452-P457, Tokyo Denki University Press”, and the like.

It is to be noted that the input spectrum Xₙ(f) may be divided into a plurality of bandwidths, in each of which a bandwidth spectrum calculated by weighted averaging or the like may be substituted for the input spectrum.

Also, an input amplitude \hat{X}ₙ(i) per bandwidth calculated by a BPF (Band Pass Filter) can be substituted for the input spectrum Xₙ(f). The input amplitude \hat{X}ₙ(i) per bandwidth is calculated by the following procedure:

Firstly, an input signal xₙ(t) is divided into a bandwidth signal \hat{x}ₙ(i,t) by the following equation:

$${\hat{x}}_{n} ( i , t ) = {\sum }_{j = 0}^{M - 1} ( BPF ( i , j ) \times {x}_{n} ( t - j ) ) \qquad Eq . ( 1 )$$

BPF(i,j): FIR filter coefficient for bandwidth division

M: FIR filter degree

i: bandwidth No.

Then, the input amplitude \hat{X}ₙ(i) per bandwidth is calculated per frame by the following equation:

$${\hat{X}}_{n} ( i ) = \frac{1}{N} {\sum }_{l = 0}^{N - 1} {\hat{x}}_{n}^{2} ( i , t - l ) ( N \text{:} frame length ) \qquad Eq . ( 2 )$$

The input spectrum thus acquired is inputted into the noise estimation device 3a and the section determination device 4a.

The noise estimation device 3a is provided with an instantaneous noise estimating portion 31, which estimates an instantaneous noise spectrum Nₙ(f) that is a noise spectrum of the present frame from an approximate form of the input spectrum Xₙ(f) calculated by the frequency domain signal analyzing portion 2. The instantaneous noise spectrum Xₙ(f) is calculated by the following procedure:

Firstly, a minimum value mₙ(k) of the spectrum is selected from the input spectrum Xₙ(f). For example, the input spectrum Xₙ(f) satisfying the following conditional equation is selected as the minimum value mₙ(k):
Xₙ(f)<Xₙ(f−1) and Xₙ(f)<Xₙ(f+1) Eq. (3)

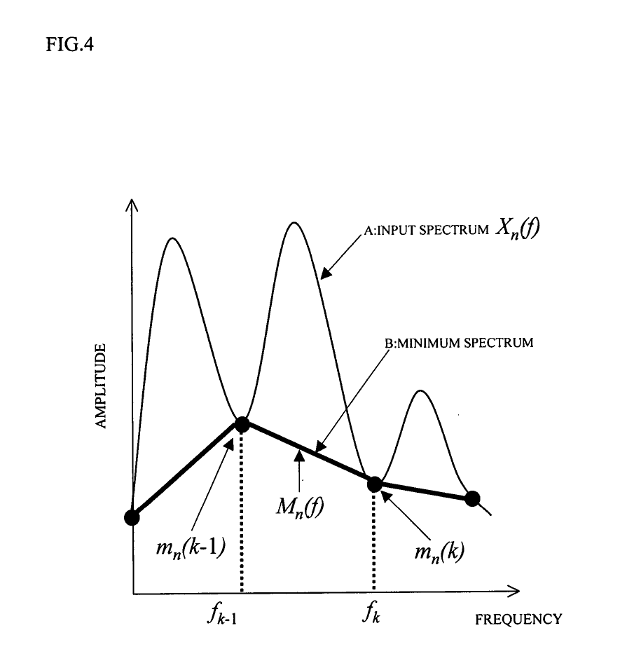

Then, a minimum spectrum Mₙ(f) (corresponding to the minimum spectrum B in FIG. 2) is calculated from the minimum value mₙ(k). If the k-th frequency is supposed to be mₙ(k), the minimum spectrum Mₙ(f) can be expressed by a function of the minimum value mₙ(k) and fₖ. For example, when e.g. the minimum spectrum Mₙ(f) is a function as shown in FIG. 4, the minimum spectrum Mₙ(f) can be expressed by the following equation:

$${M}_{n} ( f ) = {m}_{n} ( k - 1 ) + \frac{( {m}_{n} ( k ) - {m}_{n} ( k - 1 ) )}{( {f}_{k} - {f}_{k - 1} )} \times ( f - {f}_{k - 1} ) \qquad Eq . ( 4 )$$

It is to be noted that while FIG. 4 shows an example where a non-linear function is used for the calculation of the minimum spectrum Mₙ(f), a high-order polynomial equation, a linear function, and the like can be used.

Then, the instantaneous noise spectrum Nₙ(f) is calculated by using the minimum spectrum Mₙ(f) thus acquired. It is to be noted that the instantaneous noise spectrum Nₙ(f) can be specifically calculated by adding or multiplying a correction coefficient αₙ(f) to the minimum spectrum Mₙ(f).

The correction coefficient αₙ(f) may be a constant preliminarily and empirically acquired from actual noise (in consideration of dispersion of noise, or the like), or may be a variable calculated per frame. Hereinafter, cases where αₙ(f) is a variable are indicated as calculation examples 1 and 2.

As the calculation example 1, a dispersion value σₙ(f) of the input spectrum Xₙ(f) is preliminarily calculated in the past section determined as a noise section by a subsequent noise/voice determining portion 42, so that the correction coefficient αₙ(f) is calculated from the dispersion value σₙ(f). The dispersion value σₙ(f) may be calculated per frequency bandwidth, or may be calculated by weighted averaging or the like in a certain specific bandwidth.

As one example of the calculation of the correction coefficient αₙ(f) by the dispersion value σₙ(f), the following equation can be used:
αₙ(f)=γₙ(f)×σₙ(f) Eq. (5)

A coefficient Υₙ(f) is an experience value acquired experimentally.

As the calculation example 2, the correction coefficient αₙ(f) is calculated according to an integrated value Rxmₙ of the ratio between the input spectrum Xₙ(f) and the minimum spectrum Mₙ(f). The integrated value Rxmₙ is expressed by the following equation:

$${Rxm}_{n} = {\sum }_{f = 0}^{L - 1} ( \frac{{X}_{n} ( f )}{{M}_{n} ( f )} ) \\ ( L \text{:} the number of frequency bandwidths ) \qquad Eq . ( 6 )$$

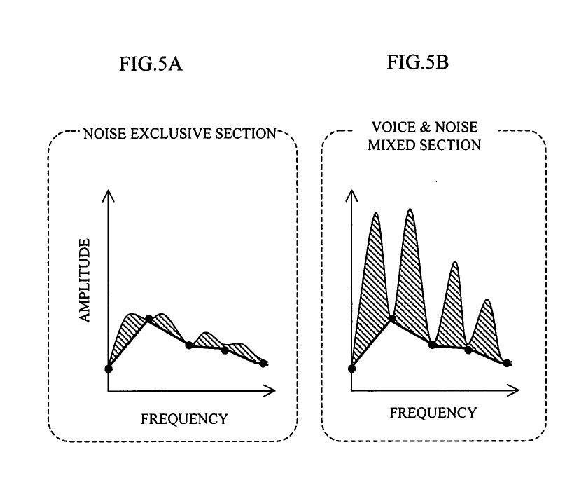

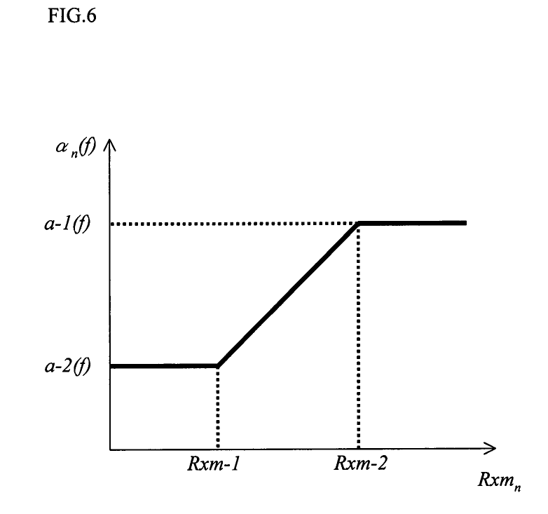

The integrated value Rxmₙ corresponds to an area of a hatching region in FIGS. 5A and 5B. The integrated value Rxmₙ is small in the noise exclusive section shown in FIG. 5A, and is large in the mixed section of voice and noise shown in FIG. 5B. Accordingly, prescribing the correction coefficient αₙ(f) as a function of the integrated value Rxmₙ as shown in e.g. FIG. 6, the correction coefficient αₙ(f) upon the instantaneous noise calculation is varied according to the contribution degree of the voice signal within the input signal, so that a noise spectrum more closer to an actual condition can be estimated.

At this time, the integrated value Rxmₙ may be calculated in a certain specific bandwidth. Also, different values may be used for Rxm−1, Rxm−2, α−1(f), and α−2(f) in frequency bandwidths, or the same value may be used in a certain specific bandwidth. This should be appropriately selected so as to correspond to an actual noise spectrum.

The instantaneous noise spectrum Nₙ(f) thus estimated by the instantaneous noise estimating portion 31 is outputted from the noise estimation device 3a.

Concurrently, the instantaneous noise spectrum Nₙ(f) is transmitted to the section determination device 4a, which is provided with a parameter calculating portion 41a for noise/voice determination and a noise/voice determining portion 42. The parameter calculating portion 41a for noise/voice determination calculates a parameter for a section determination by using the instantaneous noise spectrum Nₙ(f) calculated by the instantaneous noise estimating portion 31 and the input spectrum Xₙ(f) from the frequency domain signal analyzing portion 2.

As the parameter for the section determination, the power of the input signal is calculated from e.g. the input spectrum Xₙ(f), and the power of the instantaneous noise is calculated from the instantaneous noise spectrum Nₙ(f). The signal-noise ratio SNRₙ calculated from each power is used as the parameter for the section determination. Also, an integrated value Rₙ or the like of the signal-noise ratio per bandwidth calculated from the input spectrum Xₙ(f) and the instantaneous noise spectrum Nₙ(f) may be used as the parameter for the section determination. The integrated value Rₙ can be expressed by the following equation:

$${R}_{n} = {\sum }_{f = 0}^{L - 1} ( \frac{{X}_{n} ( f )}{{N}_{n} ( f )} ) \\ ( L \text{:} number of frequency bandwidths ) \qquad Eq . ( 7 )$$

It is to be noted that an integration range of the frequency for acquiring the integrated value Rₙ may be limited to a certain specific bandwidth for calculation.

The noise/voice determining portion 42 performs the section determination by comparing the section determination parameter calculated by the parameter calculating portion 41a for noise/voice determination with a threshold, and outputs the determination result vad_flag. Namely, if the determination result vad_flag is FALSE, it means that the frame is the mixed section including the voice, while if the determination result vad_flag is TRUE, it means that the frame is the noise section without voice.

As the section determination parameter, the signal-noise ratio SNRₙ calculated by the parameter calculating portion 41a for noise/voice determination, or the integrated value Rₙ is used. For more effective implementation, the parameter calculating portion 41a for noise/voice determination can be arranged so as to calculate both of the signal-noise ratio SNRₙ and the integrated value Rₙ, in which the section determination parameter is calculated as a function for both of the signal-noise ratio SNRₙ and the integrated value Rₙ to be used for the determination.

### Second Embodiment

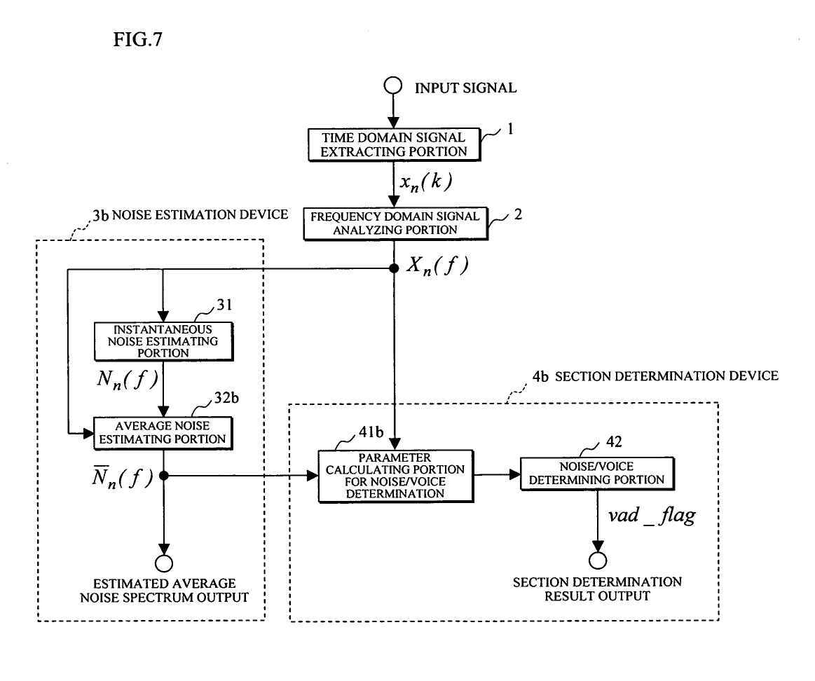

FIG. 7 shows a signal processing device which functions as the noise estimation device and the noise section determination device, according to the second embodiment of the present invention. This signal processing device is composed of the time domain signal extracting portion 1, the frequency domain signal analyzing portion 2, a noise estimation device 3b, and a section determination device 4b, in the same way as the signal processing device according to the first embodiment. In this second embodiment, the instantaneous noise spectrum unchanged is not assumed to be the estimation noise spectrum different from the first embodiment, but is used to calculate the average noise spectrum, which is outputted as the estimation noise spectrum. It is to be noted that blocks having the same reference numerals as those in FIG. 3 are the same as those in the first embodiment, so that the description thereof will be hereinafter omitted.

Namely, an average noise estimating portion 32b in the noise estimation device 3b calculates the average noise spectrum N̅ₙ(f) by using the instantaneous noise spectrum Nₙ(f) calculated by the instantaneous noise estimating portion 31. Hereinafter, as the embodiments of the average noise spectrum N̅ₙ(f), the following calculations 1 and 2 will be mentioned:

As the calculation example 1, the average noise spectrum N̅ₙ(f) is calculated by using an FIR filter. At this time, the average noise spectrum N̅ₙ(f) is calculated by weighted averaging of the instantaneous noise spectrum Nₙ(f) for the past K frames including the present frame. This can be expressed by the following equation:

$${\overline{N}}_{n} ( f ) = {\sum }_{n = 0}^{K - 1} {β}_{n} ( f ) \times {N}_{n} ( f ) \\ {β}_{n} ( f ) \text{:} weighting coefficient \qquad Eq . ( 8 )$$

A weighting coefficient βₙ(f) may be set to a different value per frequency.

As the calculation example 2, the average noise spectrum is calculated by an IIR filter. At this time, the average noise spectrum N̅ₙ(f) is calculated in a long-term average of the instantaneous noise spectrum Nₙ(f). This can be expressed by the following equation:
N̅ₙ(f)=γ(f)× N̅ₙ₋₁(f)+(1−(f))×Nₙ(f)
γ(f): weighting coefficient Eq. (9)

A weighting coefficient γₙ(f) may be set to a different value per frequency.

A parameter calculating portion 41b for noise/voice determination having received the average noise spectrum N̅ₙ(f) thus acquired by the average noise estimating portion 32b may similarly calculate the signal-noise ratio SNRₙ described in the parameter calculating portion 41a for noise/voice determination of the first embodiment and the integrated value Rₙ of the signal-noise ratio per bandwidth by using the average noise spectrum N̅ₙ(f) instead of the instantaneous noise spectrum Nₙ(f). The subsequent processing in the noise/voice determining portion 42 is the same as that of the first embodiment.

### Third Embodiment

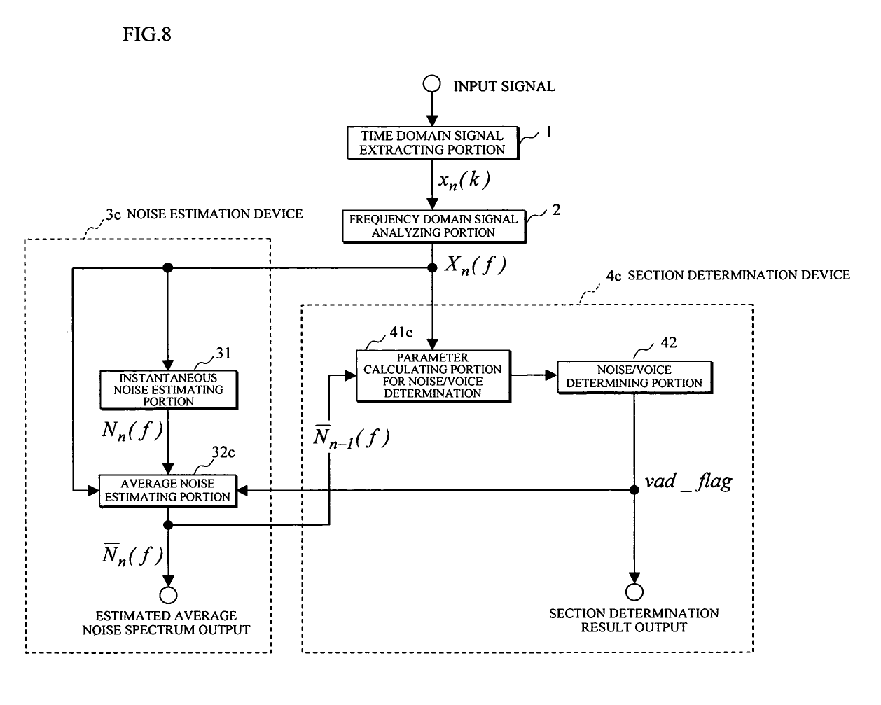

FIG. 8 shows a signal processing device which functions as the noise estimation device and the noise section determination device by the third embodiment of the present invention. This signal processing device is composed of the time domain signal extracting portion 1, the frequency domain signal analyzing portion 2, a noise estimation device 3c, and a section determination device 4c, in the same way as the signal processing device by the first embodiment. However, this embodiment is different from the second embodiment in that the input spectrum of the section determined as the noise section is used unchanged for the calculation of the average noise spectrum in the subsequent frame. It is to be noted that blocks having the same reference numerals as those in FIG. 3 are the same as those in the first embodiment, so that the description thereof will be hereinafter omitted.

An average noise estimating portion 32c calculates the average noise spectrum N̅ₙ(f). For calculating the average noise spectrum N̅ₙ(f), the section determination is performed in the section determination device 4c by using the input spectrum Xₙ(f) and the average noise spectrum N̅ₙ₋₁(f) up to the last frame.

As a result, the average noise spectrum N̅ₙ(f) is calculated by using the instantaneous noise spectrum Nₙ(f) in the section determined as the mixed section (vad_flag=FALSE), and the average noise spectrum N̅ₙ(f) is calculated by using the input spectrum Xₙ(f) in the section determined as the noise section (vad_flag=TRUE).

Namely, when the determination result indicates the noise section, the input signal is the noise component itself, so that it is only necessary to use the input spectrum without using the instantaneous noise spectrum as mentioned above.

A parameter calculating portion 41c for noise/voice determination calculates the signal-noise ratio SNRₙ calculated by the parameter calculating portion 41a for noise/voice determination of the first embodiment and the integrated value Rₙ of the signal-noise ratio per bandwidth by substituting the average noise spectrum N̅ₙ₋₁(f) up to the last frame calculated at the average noise estimating portion 32c for the instantaneous noise spectrum Nₙ(f).

### Fourth Embodiment (Noise Suppression Device)

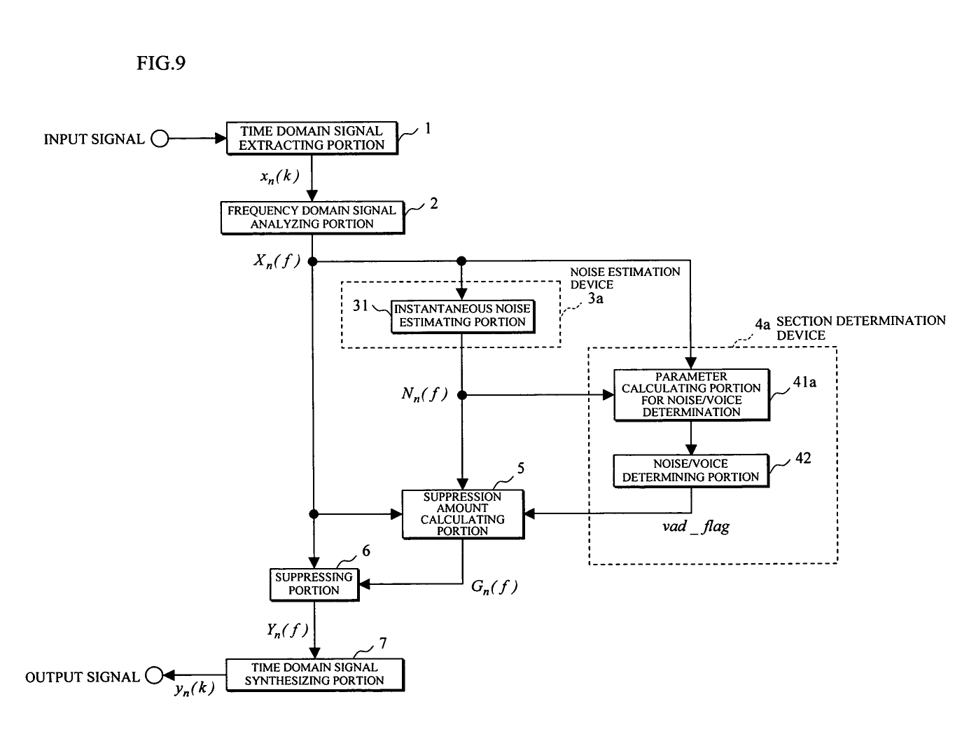

FIG. 9 shows a signal processing device which functions as a noise suppression device according to the fourth embodiment of the present invention. This noise suppression device is composed of the time domain signal extracting portion 1, the frequency domain signal analyzing portion 2, the noise estimation device 3a, and the section determination device 4a, which have been all described in the signal processing device according to the first embodiment. The noise suppression device according to the fourth embodiment is further provided with a suppression amount calculating portion 5, a suppressing portion 6, and a time domain signal synthesizing portion 7.

Firstly, the frequency domain signal analyzing portion 2 generates the input spectrum Xₙ(f) by using the FFT. The suppression amount calculating portion 5 calculates a suppression coefficient Gₙ(f) per bandwidth by using the input spectrum Xₙ(f) calculated by the frequency domain signal analyzing portion 2 and the instantaneous noise spectrum Nₙ(f) calculated by the instantaneous noise estimating portion 31. The suppression coefficient Gₙ(f) is calculated by the following equation:

$${G}_{n} ( f ) = {W}_{n} ( f ) ( 1 - \frac{{N}_{n} ( f )}{{X}_{n} ( f )} ) \\ ( 0 < {G}_{n} ( f ) < 1 ) \qquad Eq . ( 10 )$$

It is to be noted that when the determination result vad_flag at the noise/voice determining portion 42 indicates the mixed section, a coefficient Wₙ(f) in Eq. (10) is reduced, and when the determination result indicates the noise section, the coefficient Wₙ(f) is increased, thereby enabling the suppression coefficient in the noise section to be made larger than that in the mixed section. Accordingly, the suppression amount can be increased.

The suppressing portion 6 calculates an amplitude spectrum Yₙ(f) per bandwidth after the noise suppression by using the suppression coefficient Gₙ(f) calculated by the suppression amount calculating portion 5 and the input spectrum Xₙ(f). The amplitude spectrum Yₙ(f) is calculated by the following equation:
Yₙ(f)=Xₙ(f)×Gₙ(f) Eq. (11)

The time domain signal synthesizing portion 7 inversely transforms the amplitude spectrum Yₙ(f) from the frequency domain to the time domain to calculate an output signal yₙ(t) by the IFFT (Inverse Fast Fourier Transform).

While FIG. 9 uses the noise estimation device 3a and the section determination device 4a shown in the first embodiment, those shown in the second embodiment or the third embodiment may be used. At this time, the suppression amount calculating portion 5 calculates the suppression coefficient Gₙ(f) by substituting the average noise spectrum N̅ₙ(f) for the instantaneous noise spectrum Nₙ(f).

While the present invention has been described in detail by the embodiments as the above, it is obvious that the present invention is not limited by the above-mentioned embodiments. The device of the present invention can be realized as corrected and modified modes without deviating from the purpose and the scope determined by the description of the claims.

For example, when the input amplitude \hat{X}ₙ(i) per bandwidth calculated by the FIR filter is substituted for the input spectrum Xₙ(f) calculated by the FFT in the noise suppression device according to the fourth embodiment of the present invention, the output signal yₙ(t) of the time domain can be calculated by using the inverse transform corresponding to the input amplitude per bandwidth, instead of the IFFT.

What is claimed is:

1. A signal processing method comprising:
a time domain signal extraction step of extracting a time domain signal that is sampled data of an input signal;
a frequency domain signal analysis step of converting the time domain signal into a frequency domain signal per frame and calculating an input spectrum; and
a noise estimation step of estimating a noise spectrum that is a frequency domain signal of a noise component included in the input signal by using minimum components of the input spectrum.

2. The signal processing method as claimed in claim 1, wherein the noise estimation step comprises acquiring an instantaneous noise spectrum per frame as the noise spectrum.

3. The signal processing method as claimed in claim 2, wherein the noise estimation step comprises acquiring an average noise spectrum of the instantaneous noise spectrums over a plurality of frames as the noise spectrum.

4. The signal processing method as claimed in claim 1, further comprising a section determination step of comparing the noise spectrum with the input spectrum and of determining whether the frame is in a section where voice and noise are mixed or in a noise section without voice.

5. The signal processing method as claimed in claim 4, wherein when a determination result up to a last frame at the section determination step indicates the mixed section, the noise estimation step comprises acquiring the average noise spectrum by using the instantaneous noise spectrum, and when the determination result indicates the noise section, the noise estimation step comprises acquiring the average noise spectrum by using the input spectrum.

6. The signal processing method as claimed in claim 4, further comprising a suppression amount calculation step of calculating a suppression amount per bandwidth for the input signal based on the noise spectrum and the input spectrum and suppressing noise of the input signal, in consideration of a determination result at the section determination step.

7. The signal processing method as claimed in claim 1, wherein the input signal comprises a voice signal.

8. The signal processing method as claimed in claim 2, further comprising a section determination step of comparing the noise spectrum with the input spectrum and of determining whether the frame is in a section where voice and noise are mixed or in a noise section without voice.

9. The signal processing method as claimed in claim 3, further comprising a section determination step of comparing the noise spectrum with the input spectrum and of determining whether the frame is in a section where voice and noise are mixed or in a noise section without voice.

10. A signal processing device comprising:
a time domain signal extracting portion extracting a time domain signal that is sampled data of an input signal;
a frequency domain signal analyzing portion converting the time domain signal into a frequency domain signal per frame and calculating an input spectrum; and
a noise estimating portion estimating a noise spectrum that is a frequency domain signal of a noise component included in the input signal by using minimum components of the input spectrum.

11. The signal processing device as claimed in claim 10, wherein the noise estimating portion acquires an instantaneous noise spectrum per frame as the noise spectrum.

12. The signal processing device as claimed in claim 11, wherein the noise estimating portion acquires an average noise spectrum of the instantaneous noise spectrums over a plurality of frames as the noise spectrum.

13. The signal processing device as claimed in claim 10, further comprising a section determining portion comparing the noise spectrum with the input spectrum and determining whether the frame is in a section where voice and noise are mixed or in a noise section without voice.

14. The signal processing device as claimed in claim 13, wherein when a determination result up to a last frame at the section determining portion indicates the mixed section, the noise estimating portion acquires the average noise spectrum by using the instantaneous noise spectrum, and when the determination result indicates the noise section, the noise estimating portion acquires the average noise spectrum by using the input spectrum.

15. The signal processing device as claimed in claim 13, further comprising a suppression amount calculating portion calculating a suppression amount per bandwidth for the input signal based on the noise spectrum and the input spectrum and suppressing noise of the input signal, in consideration of a determination result at the section determining portion.

16. The signal processing device as claimed in claim 10, wherein the input signal comprises a voice signal.

17. The signal processing device as claimed in claim 11, further comprising a section determining portion comparing the noise spectrum with the input spectrum and determining whether the frame is in a section where voice and noise are mixed or in a noise section without voice.

18. The signal processing device as claimed in claim 12, further comprising a section determining portion comparing the noise spectrum with the input spectrum and determining whether the frame is in a section where voice and noise are mixed or in a noise section without voice.
